(19) United States
(12) Patent Application Publication
(10) Pub. No.: US 2014/0288900 A1
(43) Pub. Date: Sep. 25, 2014

(54) METHOD FOR EXPLOITING A GEOLOGICAL RESERVOIR BY MEANS OF A RESERVOIR MODEL CONSISTENT WITH A GEOLOGICAL MODEL BY THE CHOICE OF AN UPSCALING METHOD

(71) Applicant: IFP Energies nouvelles, Rueil-Malmaison Cedex (FR)

(72) Inventors: Christophe PREUX, ACHERES (FR); Mickaele LE RAVALEC, RUEIL-MALMAISON (FR); Guillaume ENCHERY, RUEIL-MALMAISON (FR)

(73) Assignee: IFP Energies nouvelles, Rueil-Malmaison Cedex (FR)

(21) Appl. No.: 14/220,182

(22) Filed: Mar. 20, 2014

(30) Foreign Application Priority Data
Mar. 20, 2013 (FR) 13/52.492

(51) Int. Cl. G01V 11/00; G01V 9/02

(52) U.S. Cl. CPC G01V 11/00; G01V 9/02
USPC 703/2; 703/10

(57) ABSTRACT

The invention IS a method for exploiting (EXP) a geological reservoir by using a reservoir model consistent with a geological model (MG). Reservoir models (MRn) are constructed by using different upscaling methods. By utilization of a connectivity study, conducted on the basis of an algorithm resolving the shortest path (DIS) applied to the meshings, the main flowpaths are identified between the wells for the geological model (MG) and for the different reservoir models (MRn). The reservoir model (MR) for which the lengths of the main flowpaths between wells are closest to those obtained for the starting geological model is then selected.

### CROSS REFERENCE TO RELATED APPLICATION

Reference is made to French application Ser. No. 13/52.493, filed Mar. 20, 2013, which application is incorporated herein by reference in its entirety.

### BACKGROUND OF THE INVENTION

1. Field of the Invention

The present invention relates to the oil industry, and more particularly to the exploitation of underground reservoirs, such as oil reservoirs or gas storage sites.

2. Description of the Prior Art

In order to best exploit the underground media, the oil industries define models to make it possible to better control and exploit the oil fields.

The first step in these studies creates an initial model, called a geological model, which best represents the geological and petrophysical data of the porous media such as the reservoir faces, permeabilities or porosities. The geological model is the model of the subsoil and is representative of both of its structure and of its behavior. Generally, this type of model is represented on a programmed computer which executes software to provide the model, and is called a numerical model. A geological model comprises a grid (or meshing) of fine resolution, generally three-dimensional, associated with one or more maps of petrophysical properties (porosity, permeability, saturation, etc.). Association is the assigning of values of these petrophysical properties to each of the meshes of the grid.

Generally, the geological model is too large for the flow of the fluids to be simulated therein since the geological model generally comprises far too many meshes for the computing power of the computers and the flow simulation takes far too long or is simply impossible to perform.

To allow for the simulation of the flows of the fluids, an upscaling step is carried out. Upscaling defines a second, coarser model, called the reservoir model. Such a model also is a model of the subsoil which is representative both of its structure and of its behavior. Generally, this type of model is represented on a programmed computer which executes software to provide the reservoir model and is referred to as numerical model. A reservoir model comprises a grid (or meshing), generally three-dimensional, associated with one or more maps of petrophysical properties (porosity, permeability, saturation, etc.).

The reservoir model comprises fewer meshes than the geological model and can therefore be used to perform the flow simulations with a reasonable computation time. During this upscaling step, the geological and petrophysical properties assigned to the fine model (geological model) are transferred to the coarse model (reservoir model) through upscaling methods. These methods are applied to compute equivalent properties which are assigned to the coarse meshes.

The geological models and the reservoir models that are well known and widely used in the oil industry make it possible to determine numerous technical parameters relating to the study or exploitation of a reservoir, such as hydrocarbons. In practice, since the reservoir model is representative of the structure of the reservoir and of its behavior, it is used for example to determine the areas which have the greatest chances of containing hydrocarbons, the areas in which it may be interesting or necessary to drill an injection or production well to improve the recovery of the hydrocarbons, the type of tools to be used, the properties of the fluids to be used and recovered, etc. These interpretations of reservoir models in terms of “exploitation technical parameters” are well known. Similarly, the modeling of the CO₂ storage sites makes it possible to monitor these sites, to detect abnormal behaviors and to predict the movement of the injected CO₂.

The purpose of a reservoir model is therefore to give the best possible account of all the information that is known concerning a reservoir. A reservoir model is representative when a reservoir simulation for this model provides history data estimations that are very close to the observed data. History data are the production data obtained from measurements on the wells in response to the production from the reservoir (production of oil, production of water from one or more wells, gas/oil ratio (GOR), proportion of production water (water cut), and/or the repetitive seismic data (4D seismic impedances in one or more regions, etc.).

A reservoir simulation is a technique that makes it possible to simulate the fluid flows within a reservoir by means of software executed on a computer which is called a flow simulator and of the reservoir model. For example, the PumaFlow® software (IFP Energies nouvelles, France) is a flow simulator.

For this, the integration of all the available data is essential. These data generally comprise:
measurements at points of the geological formation as for example in wells. These data are said to be static because they do not vary over time (on the reservoir production time scale).
“history data”, comprising production data, for example of the fluid flow rates measured on the wells, the concentrations of tracers and data obtained from seismic acquisition campaigns repeated at successive times. These data are said to be dynamic because they evolve in the course of exploitation and are indirectly linked to the properties assigned to the meshes of the reservoir model.

There are many upscaling methods from which the reservoir engineer has to make a choice. Among the methods used, it is possible to cite, for example, the arithmetical method, the harmonic method, the geometrical method, the algebraic isotropic method, the bounds combination method and the numerical methods based on the solving of the Darcy equation. This list is not exhaustive. It is very difficult to know in advance which method will provide the most satisfactory results which are closest to the results that are available for the fine model, without testing them all through flow simulations.

The choice of the upscaling method to be used is crucial to the accuracy of the reservoir model. Different criteria of choice have been proposed by a number of authors, and these criteria make it possible to quantify the error induced on the model during the upscaling phase:
Qi, D., 2010. Upscaling Extent vs. Information Loss in Reservoir Upscaling. Petroleum Science and Technology, Volume 28, Issue 12, pp 1197-1202.
Sablok, C., Aziz, K., 2005. Upscaling and Discretization Errors in Reservoir Simulation. SPESimulation Symposium, 31 Jan.-2 Feb. 2005, Houston, Tex., U.S.A, SPE 93372.
Preux, C., 2011. Study of Evaluation Criteria for Reservoir Upscaling, 73^{rd} EAGE Conference and Exhibition incorporating SPE EUROPEC 2011 Vienna, Austria, 23-26 May.

However, none of these documents involves any criterion based on a study of connectivity. Connectivity is an important parameter that makes it possible to render the reservoir model consistent with the geological model and, a fortiori, with the properties of the geological reservoir.

### SUMMARY OF THE INVENTION

To resolve this problem, the invention relates to a method for exploiting a geological reservoir by a reservoir model consistent with a geological model. For this method, a plurality of reservoir models are constructed using different upscaling methods. Through a connectivity study, conducted on the basis of an algorithm making it possible to resolve the shortest path problem applied to the meshings, the main flowpaths are identified between the wells for the geological model and for the different reservoir models. The reservoir model for which the lengths of the main flowpaths between wells are closest to those obtained for the starting geological model is then selected. This calculation of distances between wells is very rapid and makes it possible to choose the upscaling method that is most appropriate for this oil field model.

The invention relates to a method for exploiting a geological reservoir using a geological model representative of petrophysical and geological properties of the reservoir. The reservoir is passed through by at least one production well and at least one injection well for the injection of at least one fluid into the reservoir. For this method, the following steps are carried out:
a) a plurality of reservoir models are constructed that are representative of the properties of the reservoir from the geological model using at least two scale-changing methods;
b) at least one flow distance of the fluid according to the shortest path between the injection well and the production well is determined for the geological model and for each reservoir model by use of a shortest path computation algorithm with the shortest path algorithm being constrained by the reservoir properties of each model;
c) the flows of the fluid and of hydrocarbons present in the reservoir are simulated by use of a flow simulator and the reservoir model which minimizes the difference between the flow distance according to the shortest path of the reservoir model and the flow distance according to the shortest path of the geological model; and
d) the geological reservoir is exploited by use of the simulation.

According to the invention, the geological model is formed by use of geostatistical simulations from data measured for the geological reservoir.

Advantageously, the scale-changing methods are chosen in particular from: an arithmetical method, a harmonic method, a geometrical method, an algebraic and isotropic method, a bounds combination method and numerical methods based on solving the Darcy equation.

Preferably, the shortest path algorithm is the Dijkstra algorithm.

Advantageously, the geological model and the reservoir models are constructed from a set of meshes with the length of a link between two adjacent meshes i and j used by the shortest path algorithm is defined by a formula:

$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$

with:
T_{i⇄j} being transmissivity between the meshes i and j,
Aᵢⱼ being an intersection surface area between the meshes i and j,
Dᵢⱼ being a distance between the meshes i and j,
Kᵢⱼ being an average permeability along the connection between the meshes i and j,
Vpᵢ being a porous volume of the mesh i,
Vpⱼ being a porous volume of the mesh j,
Pᵢ being a fluid pressure in the mesh i, and
Pⱼ being a fluid pressure in the mesh j.

Furthermore, before the exploitation of the reservoir, a history matching step can be carried out to determine the reservoir model which minimizes an objective function, and in which, for the history matching step, the upscaling of the geological model is performed with a scale-changing method which minimizes a difference between the flow distance according to the shortest path of the reservoir model and the flow distance according to the shortest path of the geological model.

Furthermore, before the exploitation of the reservoir, a step of analyzing sensitivities of the properties of the reservoir can be carried out.

According to one embodiment of the invention, at least one scale-changing method is parameterizable, the steps a) and b) are repeated by modifying at least one parameter of the parameterizable scale-changing method to minimize a difference between the flow distance according to the shortest path of the reservoir model and the flow distance according to the shortest path of the geological model.

The invention also relates to a computer program product which may be stored in a tangible medium that can be downloaded from a communication network and/or stored on a computer-readable medium and/or that can be executed by a processor, comprising program code instructions for implementing the method according to the invention, when the program is executed on a computer.

### BRIEF DESCRIPTION OF THE DRAWINGS

Other features and advantages of the method according to the invention will become apparent on reading the following description of nonlimiting exemplary embodiments, with reference to the figures attached and described hereinbelow.

FIG. 1 illustrates an algorithm of the method according to the invention.

FIG. 2 is an exemplary illustration of a geological model.

FIG. 3 illustrates the injected water pressure and flow rate determined for different reservoir models obtained by different methods for upscaling the geological model of example 2.

FIG. 4 illustrates the pressure on the injector for reservoir models OF the example of FIG. 3.

FIG. 5 illustrates the bottom pressure and the flow rate obtained on the surface at the production well for the example of FIG. 3.

### DETAILED DESCRIPTION OF THE INVENTION

The invention relates to a method for exploiting a geological reservoir, notably a reservoir containing hydrocarbons. The geological reservoir is passed through by at least one production well and at least one injection well for performing the injection of at least one fluid (for example water) into the reservoir. “Hydrocarbons” should be understood, within the meaning of the present invention, to mean oil-bearing products such as petroleum or crude oil, petroleum or extra-heavy oil, asphaltenic sands, bituminous schists and gases present in a subterranean formation.

By means of the method according to the invention, a scheme for exploiting the reservoir is defined by use of a flow simulation for a reservoir model representative of the petrophysical and geological properties of the reservoir. The reservoir model that is used is chosen from reservoir models obtained by different upscaling methods.

FIG. 1 illustrates the different steps of the method according to the invention:
1. The obtaining of a geological model of the reservoir (MG)
2. The construction of reservoir models (MRn)
3. The computation of the flow distances according to the shortest path (DIS)
4. The choice of the reservoir model (MR)
5. The flow simulation (SIM)
6. The exploitation of the geological reservoir (EXP)

1. The Obtaining of a Geological Model of the Reservoir (MG)

This first step constructs, by use of suitable software, a geological model comprising a meshing and petrophysical properties applied to the meshes. Advantageously, the geological model is formed by use of geostatistical simulations based on data measured for the geological reservoir. These measured data can be measurements at points of the geological formation, for example in wells, and optionally “history data”, comprising production data which for example may be the fluid flow rates measured on the wells, the tracer concentrations and data obtained from seismic acquisition campaigns repeated at successive times. It should be noted that the geological model is a model which comprises a fine meshing.

2. The Construction of a Number of Reservoir Models (MRn)

During this step, a number of reservoir models are constructed which are obtained by different (at least two) methods for upscaling the geological model. It should be noted that the reservoir model is a model comprising a coarse meshing which comprises fewer meshes than the fine meshing of the geological model. During the upscaling step, the geological and petrophysical properties assigned to the fine model (geological model) are transferred to the coarse model (reservoir model).

The different upscaling methods can be chosen in particular from an arithmetic and method, a harmonic method, a geometrical method, an algebraic and isotropic method, a bounds combination method and numerical methods based on solving the Darcy equation. This list is not exhaustive. The upscaling methods are applied to compute equivalent properties which are assigned to the coarse meshes.

3. The Computation of the Flow Distances According to the Shortest Path (DIS)

For each geological model and the reservoir model, at least one flow distance of the fluid according to the shortest path between the injection well and the production well is determined. Advantageously, for each injection well, all the paths between the injection well and an associated production well which are production wells which are assigned by the injector, are computed (the choice of the producers “linked” to the injector is generally made by looking at the exploitation scheme. In the case of a “five spot”, the paths between the injection well and its production wells are computed, but the distance between the injection well and a production well which forms part of another “five spot” further away on the field is not computed since it has no use.

The shortest path is dependent on the petrophysical and geological properties of the reservoir, notably the permeability, contained in the meshes of the models. According to the invention, to compute the shortest path, a shortest path computation algorithm is implemented.

The shortest path computation problems as also called routing problems and are conventional graph theory problems. The objective is to compute a route between peaks of a graph which minimizes or maximizes an economical function. There are polynomial algorithms for resolving this problem such as the Dijkstra algorithm.

According to one embodiment of the invention, the Dijkstra algorithm is used to determine the flow distance between the injection well and the production well according to the shortest path. Other algorithms, such as the Ford-Bellman algorithm or the Gabow algorithm can be used for the method according to the invention. This list is not exhaustive.

Advantageously, the length of a link between two adjacent meshes i and j of the models used by the shortest path computation algorithm is defined by a formula of the type:

$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$

with:
T_{i⇄j} being transmissivity between the meshes i and j,
A_{i,j} being an intersection surface area between the meshes i and j,
D_{i,j} being a the distance between the meshes i and j,
K_{i,j} being an average permeability along the connection between the meshes i and j,
Vpᵢ being a porous volume of the mesh i,
Vpⱼ being aporous volume of the mesh j,
Pᵢ being a fluid pressure in the mesh i, and
Pⱼ being a fluid pressure in the mesh j.

4. The Choice of the Reservoir Model (MR)

During this step, the distances obtained for each reservoir model are compared to those obtained for the geological model.

The reservoir model is chosen for the flow distances between wells which are closest to those of the geological model. If a number of distances between a plurality of injection wells and a plurality of production wells are computed, the sum of the distances can be compared and the average of the distances can be compared, or the least squares method can be applied.

5. The Flow Simulation (SIM)

By use of a flow simulator, for example the PumaFlow® software (IFP Energies nouvelles, France), the flows of the injected fluid and of the hydrocarbons present in the reservoir are simulated on the basis of the reservoir model chosen in the preceding step. It is possible, for example, to simulate the recovery of oil or the displacements of the fluids (for example the stored gases) in the reservoir.

According to one embodiment of the invention, from the reservoir model determined in the preceding steps, exploitation schemes can be determined corresponding to different possible configurations for exploitation of the underground reservoir including positioning of the production and/or injection wells, target values for the flow rates for each well and/or for the reservoir, type of tools to be used, fluids to be used, injected and/or recovered, etc. For each of these schemes, it is best to determine production forecasts. The production forecasts are probabilities and are obtained by use of the flow simulation software and by the selected numerical reservoir model.

One or more possible exploitation schemes are then defined which are suited to the reservoir model. For each of these schemes, the responses can be determined by simulation.

From the probabilistic production forecasts defined for each exploitation scheme, a comparison is used to choose the exploitation scheme which is most relevant. For example:
by comparing the maximum of the recovered oil volume, it is possible to determine the production scheme that is likely to provide the maximum recovery or be the most cost-effective.
by comparing the standard deviation of the recovered oil volume, it is possible to determine the production scheme with the least risk.

6. The Exploitation of the Geological Reservoir (EXP)

The reservoir is then exploited according to the simulation or, where appropriate, according to the most relevant exploitation scheme, for example by drilling new wells (production or injection), by modifying the tools which are used, by modifying the flow rates and/or the nature of the fluids which are injected, etc.

The invention also relates to a computer program product which may be stored in a tangible medium that can be downloaded from a communication network and/or stored on a computer-readable medium and/or that can be executed by a processor. This program comprises program code instructions for implementing the method as described above, when the program is executed on a computer.

### Alternative Embodiments

According to a first alternative embodiment of the method according to the invention, before the step of exploitation of the geological reservoir, a step of history matching of the models is carried out. The history matching modifies the parameters of the geological model, such as the permeabilities, the porosities or the skins of wells (representing damage around the well), the fault line connections, etc., to minimize the deviations between the measured history data and the corresponding responses simulated on the basis of the reservoir model. The parameters can be linked to geographic regions like the permeabilities or porosities around a well or a plurality of wells. The difference between the history data and simulated responses forms a functional, called the “objective function.” The history matching problem is resolved by minimizing this functional.

For the minimization of the objective function, the geological model is modified on each iteration and then, to perform a flow simulation, a change of scale is applied to form at least one reservoir model. Advantageously, the same scale-changing method, which corresponds to the scale-changing method which minimizes the difference of the shortest path distances between the geological model and the reservoir models, is used on each iteration. Alternatively, in addition to modifying the geological model, it is possible to construct, on each iteration, a plurality of reservoir models by use of scale-changing methods and the most appropriate “upscaling” method is deduced therefrom on each iteration.

According to a second alternative embodiment of the method according to the invention, before the exploitation step, a step of determining sensitivities of the petrophysical and geological properties of the reservoir models is carried out to determine their influence on the simulations.

According to a third alternative embodiment of the method according to the invention, at least one of the scale-changing methods is parameterizable and an optimization loop is produced to determine the parameter of the method which minimizes the difference of the shortest path differences. For example, for this variant embodiment, the following steps can be implemented:

1. A value of the parameter p of the scale-changing method is chosen;

2. At least one reservoir model is constructed by means of the scale-changing method and of the parameter p;

3. The shortest path distances are determined as described above;

4. The parameter p is modified and the steps 2 and 3 are reiterated; and

5. The reservoir model which minimizes the difference of the shortest path distances is chosen.

Exemplary Application

In order to demonstrate the benefit of the method for the exploitation of hydrocarbon deposits, it is applied to a simplified oil field case.

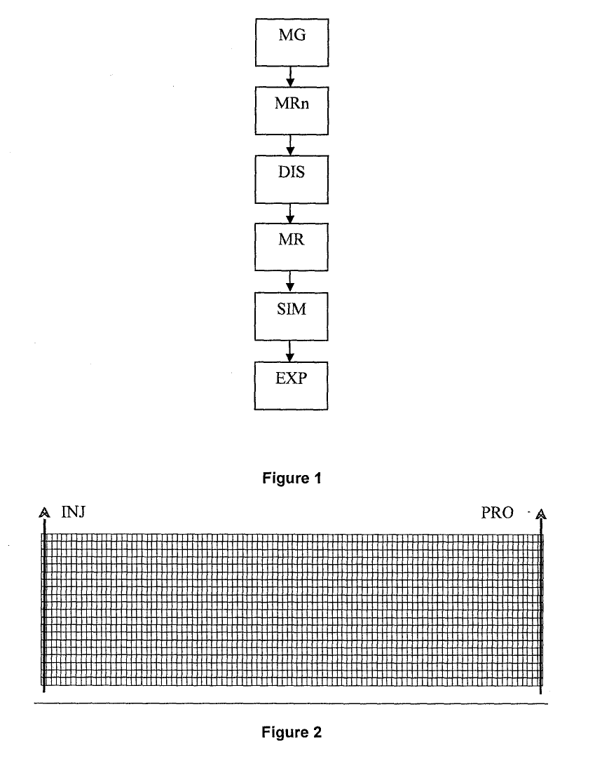

The focus here is on a geological model comprising 100*1*20=2000 fine meshes. This model is assigned petrophysical properties from geostatistical simulation tools. There is also a reservoir grid of 25*1*5 meshes available. Furthermore, two wells are considered which are an injection well (INJ) situated on the left edge of the grid and a production well (PRO) situated on the right edge of the grid, as shown in FIG. 2.

In order to assign the reservoir grid with petrophysical properties, different upscaling methods are tested which are

the arithmetical method,

the harmonic method,

the geometrical method,

the algebraic isotropic method,

the bounds combination method,

the numerical method based on Darcy resolution.

The connectivity is studied for all the models obtained by using a Dijkstra algorithm resolving the shortest path problem, which provides the following distance values between the two wells set out in Table 1 below:

TABLE 1
Shortest path distances for different reservoir models

| Models | Distance |
|---|---|
| Geological (FIN) | 0.25211331 |
| Arithmetic (MR1) | 0.583567881 |
| Harmonic (MR2) | 16.25388547 |
| Geometrical (MR3) | 3.160463059 |
| Algebraic isotropic (MR4) | 0.732890674 |
| Bounds combination (MR5) | 0.732890674 |
| Numerical (MR6) | 0.671955491 |

From the values obtained, it is deduced therefrom that the best method for this case is the arithmetical method (MR1). The harmonic method (MR2) is the worst, followed by the geometrical method (MR3). Finally, the last three methods (algebraic isotropic (MR4), bounds combination (MR5) and numerical (MR6)) are substantially at the same level of accuracy.

In order to determine that, a water injection is simulated and a determination is made to ensure that the responses to the wells in terms of recovery of hydrocarbons and of operation of the field are consistent with the results obtained by following this methodology.

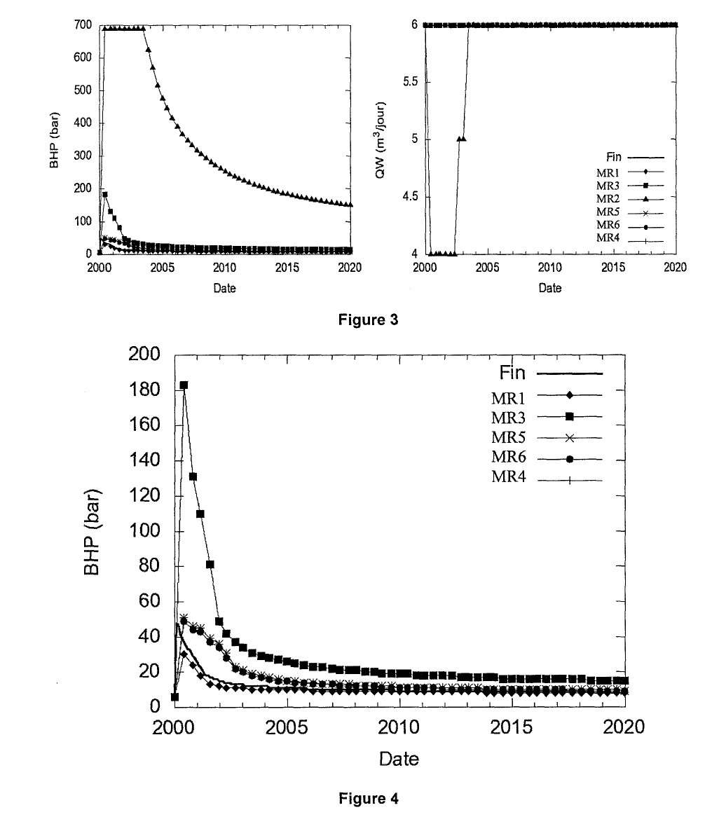

FIG. 3 illustrates, for these different models, the pressure of the injector (BHP) and the injected water flow rate (QW) as a function of time (Date). By looking at the results on the injector, it can immediately be seen that the harmonic method (MR2) is the worst. It does not comply with the operation of the well which operates at the start with imposed pressure. This is in line with the results of the methodology (see FIG. 3).

The harmonic method is therefore eliminated and the analysis of the flow simulation results obtained on wells is continued.

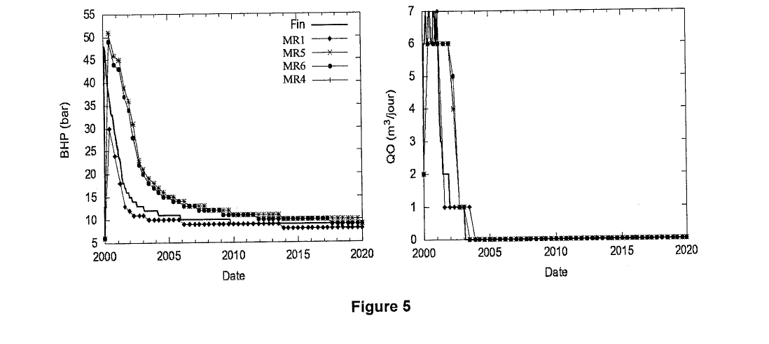

The examination of the bottom pressure (BHP) of the injection well (see FIG. 4) is continued. It is noted that the geometrical method (MR3) widely overestimates the pressure compared to all the other methods. The choice of the reservoir model as used by the method according to the invention effectively ranks this method as the second worst. It can therefore be eliminated.

By studying the pressure (BHP) on the injector (see FIG. 4), and the flow rate of oil (QO) in surface condition on the producer (see FIG. 5), it is noted that the method that is of most interest, that is to say closest to the fine simulation, is the arithmetical method (MR1), as predicted by the methodology according to the invention. Furthermore, a determination is carried out to ensure that the last three methods (MR4, MR5 and MR6) give results that are substantially similar, but are less favorable than those obtained with the arithmetical method (MR1).

1-9. (canceled)

10. A method for exploiting a geological reservoir using a geological model representative of petrophysical and geological properties of the reservoir which is passed through by at least one production well and at least one injection well for injecting at least one fluid into the reservoir comprising:
a) constructing reservoir models with software which is executed on a computer to be representative of the properties of the reservoir from the geological model by use of at least two scale-changing methods;
b) determining at least one flow distance of the at least one fluid according to a shortest path between the at least one injection well and the at least one production well for the geological model which is executed by software on a computer and for each reservoir model by using a shortest path computation algorithm with the shortest path algorithm being constrained by the reservoir properties of each reservoir model;
c) simulating flows of the fluid and of hydrocarbons present in the reservoir with a flow simulator which is provided by software executed on a computer and the reservoir model which minimizes a difference between the flow distance according to the shortest path of the reservoir model and the flow distance according to the shortest path of the geological model; and
d) using the simulation in exploitation of the geological reservoir.

11. A method according to claim 10, comprising forming the geological model by using geostatistical simulations from data measured for the geological reservoir.

12. A method according to claim 10 comprising choosing the scale-changing methods from an arithmetical method, a harmonic method, a geometrical method, an algebraic and isotropic method, a bounds combination method and/or numerical methods based on solving the Darcy equation.

13. A method according to claim 11 comprising choosing the scale-changing methods from an arithmetical method, a harmonic method, a geometrical method, an algebraic and isotropic method, a bounds combination method and/or numerical methods based on solving the Darcy equation.

14. A method according to claim 10, wherein the shortest path algorithm is the Dijkstra algorithm.

15. A method according to claim 11, wherein the shortest path algorithm is the Dijkstra algorithm.

16. A method according to claim 12, wherein the shortest path algorithm is the Dijkstra algorithm.

17. A method according to claim 13, wherein the shortest path algorithm is the Dijkstra algorithm.

18. A method according to claim 19 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄ j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

19. A method according to claim 11 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

20. A method according to claim 12 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

21. A method according to claim 13 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

22. A method according to claim 14 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

23. A method according to claim 15 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

24. A method according to claim 16 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

25. A method according to claim 17 comprising constructing the geological model and the reservoir models from a set of meshes and a length of a link between two adjacent meshes i and j used by the shortest path algorithm defined by a formula:
$${Length}_{i \to j} = \frac{\sqrt{{Vp}_{i} \times {Vp}_{j}}}{{T}_{i ↔ j} ( {P}_{i} - {P}_{j} )} with {T}_{i ↔ j} = \frac{{A}_{ij} {K}_{ij}}{{D}_{ij}}$$
with:
Ti⇄j being transmissivity between the meshes i and j,
Aij being an intersection surface area between the meshes i and j,
Dij being a distance between the meshes i and j,
Kij being an average permeability along the connection between the meshes i and j,
Vpi being a porous volume of the mesh i,
Vpj being a porous volume of the mesh j,
Pi being a fluid pressure in the mesh i, and
Pj being a fluid pressure in the mesh j.

26. A method according to claim 10 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

27. A method according to claim 11 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

28. A method according to claim 12 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

29. A method according to claim 13 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

30. A method according to claim 14 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

31. A method according to claim 15 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

32. A method according to claim 16 comprising carrying out a history matching step before the exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

33. A method according to claim 17 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

34. A method according to claim 18 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

35. A method according to claim 19 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

36. A method according to claim 20 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

37. A method according to claim 21 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

38. A method according to claim 22 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

39. A method according to claim 23 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

40. A method according to claim 24 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

41. A method according to claim 25 comprising carrying out a history matching step before exploitation of the reservoir to determine a reservoir model minimizing an objective function and for the history matching step performing an upscaling of the geological model with the scale-changing method minimizing a difference between the flow distance according to the shortest path of the reservoir model and the flow distance according to the shortest path of the geological model.

42. A method according to claim 10 comprising analyzing sensitivities of the properties of the reservoir before exploitation of the reservoir.

43. A method according to claim 11 comprising analyzing sensitivities of the properties of the reservoir before exploitation of the reservoir.

44. A method according to claim 12 comprising analyzing sensitivities of the properties of the reservoir before exploitation of the reservoir.

45. A method according to claim 14 comprising analyzing sensitivities of the properties of the reservoir before exploitation of the reservoir.

46. A method according to claim 18 comprising analyzing sensitivities of the properties of the reservoir before exploitation of the reservoir.

47. A method according to claim 10 wherein when at least one scale-changing method is parameterizable and comprising repeating steps a) and b) by modifying at least one parameter of the parameterizable scale-changing method to minimize a difference between the flow distance according to the shortest path of the reservoir model and the flow distance according to the shortest path of said geological model.

48. A computer program product that can be downloaded from a communication network and/or stored on a computer-readable medium and is executed by a processor, comprising program code instructions for implementing the method according to claim 10.
